(19) United States
(12) Patent Application Publication
(10) Pub. No.: US 2013/0005810 A1
(43) Pub. Date: Jan. 3, 2013

(54) ORGANIC UNCOUPLING AGENTS

(75) Inventors: Roland Jacquot, Francheville (FR); Luc Louvel, Lyon (FR); Philippe Marchal, Sainte-Genis (FR); Philippe Marion, Vernaison (FR); Gilles Moreau, Sainte Consorce (FR); Agnes Pilas-Begue, Miribel (FR)

(73) Assignee: RHODIA OPERATIONS, Aubervilliers (FR)

(21) Appl. No.: 13/497,212

(22) PCT Filed: Jul. 26, 2010
(86) PCT No.: PCT/EP2010/060792

§ 371 Date: Sep. 11, 2012

(30) Foreign Application Priority Data
Sep. 22, 2009 (FR) 09 04509

(51) Int. Cl. A01N 37/44; A01N 31/02; A01P 1/00; A01N 35/04

(52) U.S. Cl. 514/556; 514/699; 514/738

(57) ABSTRACT

The present invention relates to a method for controlling the growth of bacterial biomass in an aqueous system, including adding to the aqueous system or contacting the aqueous system, with an efficient amount of an uncoupling agent selected from vanillin, pentaerythritol and a betaine of general formula (1): (R)₃N+═[CH₂]ₙ═CO₂⁻ wherein the R groups, are identical or different, and are selected from a linear or branched alkyl group having 1 to 8 carbon atoms, and n is a number between 1 and 5.

The invention relates to organic derivatives and to their use as uncoupling agents. The invention relates to these uncoupling agents, with view to use within the scope of controlling the bacterial biomass in aqueous systems, in particular in a waste water treatment plant, as well as to the use of these agents, and to a method for using these agents.

The uncoupling activity of a molecule consists in acting on the bacterial cell energetics so as to reduce the biomass production of waste waters while keeping the purifying activity of the bacterial cell by biological degradation of organic molecules. The details of the biochemistry and of the mechanism involved in the respiration of cells are for example discussed in the publication <<Biochemistry>>, 3^{rd} edition, author: Lubert Stryer, editor: W. H. Freemen & Company, New York, USA, 1998 and also in the publication <<General Microbiology>>, 3^{rd} edition, authors: Roger Y. Stanier, Michael Doudoroff and Edward A. Adelberg, editor: Macmillan, 1971.

The uncoupling activity of a molecule on bacterial growth is in fine expressed by overconsumption of oxygen induced by unbalance of the bacterial energetics.

This uncoupling activity of a molecule is of interest for an application in a waste water treatment plant, designated subsequently by the French abbreviation STEP, in the case when it allows significant reduction at the source of the production of activated sludges.

The production of biomass and therefore of activated sludges in the treatment of waste waters, originates from the consumption of nutrients in the waste waters. By a respiratory process, the nutrients are oxidized and this releases energy which may be used by microorganisms within the scope of cell division. Now, the consumption of nutrients induces a flow of protons at the bacterial membrane by the phenomenon of oxidative phosphorylation; this flow will establish a proton gradient which itself operates proton pumps which allow synthesis of ATP(Adenosine TriPhosphate) from ADP+P at the ATP synthetase enzyme complex. ATP provides energy to the cell during cell processes (including cell division).

If this energy release could be avoided, this would lead to a decrease in biomass generation by inhibiting energy production. The uncoupling corresponds to inhibition of the formation of energy supplies in the form of ATP. An uncoupling agent reduces the energetic yield of the combustion of carbon while increasing the proportion of carbon oxidized into CO₂. The uncoupling is therefore expressed by less production of biomass and by greater consumption of oxygen.

The bacterial biomass produced during wastewater treatment is expensive to remove and therefore a decrease in the biomass leads to a reduction in the costs of removal.

An aim of the present invention is to propose uncoupling molecules, for which the efficiency is measured by a drop in the production of biological sludges at the source, i.e. in aeration tanks of urban waste water treatment plants, by at least 30%.

Another purpose of the present invention is to propose uncoupling molecules, for which the efficiency is substantially equivalent, or even greater than that of the reference molecule THPS (Tetrakis Hydroxymethyl Phosphonium), the efficiency of which on the reduction of biological sludge production has been shown in patent application WO 2004/113236.

Another aim of the present invention is to propose alternative uncoupling molecules to THPS, for which abiotic and biotic degradability is less rapid than that of THPS without, however, said molecules be non-degradable which would pose environment issues.

Another purpose of the present invention is to propose uncoupling molecules, for which the toxicological and ecotoxicological profile is satisfactory and suitable for their use in STEP. Indeed, these molecules must have low impact on the environment and in fine be biodegradable while having biotic and abiotic degradation allowing them to have a satisfactory reactivity on bacterial biomass. These objectives and other ones are achieved by the present invention which indeed relates to a method enabling controlling growth of bacterial biomass in an aqueous medium, comprising adding to the aqueous system, or contacting with the aqueous system, an effective amount of an uncoupling agent selected from vanillin, pentaerythritol, and a betaine of general formula (1):

(R)₃N⁺—[CH₂]ₙ—CO₂⁻ (1)

wherein:

the groups R, either identical or different, are selected from a linear or branched alkyl group, having from 1 to 8 carbon atoms and n is a number comprised between 1 and 5.

Preferably, R is a methyl group, n is 1 and the product of formula (1) is designated in the literature as trimethylglycine, N-trimethylglycine, glycine betaine or glycine of formula (2):

(CH₃)₃N⁺—CH₂—CO₂ (2)

The effective amount of uncoupling agent added to the aqueous system can represent up to 5,000 mg/l, for example up to 3,000 mg/l, such as, up to 1,000 mg/l. Preferably, the effective amount of uncoupling agent added to the aqueous system represents from 0.005 mg/l to 500 mg/l, for example from 0.01 mg/l to 300 mg/l, such as from 0.05 mg/l to 100 mg/l. More preferably, the effective amount of uncoupling agent represents from 0.1 to 10 mg/l, for example, from 0.5 mg/l to 7.5 mg/l, such as from 1 to 5 mg/l.

The uncoupling agent may be formulated with one or more of the following chemicals conventionally used in the treatment of waste waters:

a surfactant;

an antifoam agent;

a scale inhibitor;

a corrosion inhibitor;

a biocide;

a flocculant;

an agent facilitating solids/water separation; and

a dispersant.

Preferably the aqueous system will be a waste water treatment plant unit, which is used for treating industrial or municipal effluents. This installation recovers waste waters from industrial processes (for example, paper production, food industry, chemical industry) and/or dwellings and institutional buildings and similar installations, by using microorganisms in anoxic, aerobic processes (for example denitrification), for consuming organic pollutants and making the water suitable for being re-used or discarded into the environment.

The present invention therefore proposes a method for controlling the growth of bacterial biomass in an aqueous system, which method comprises putting an effective amount of an uncoupling agent as defined above, directly into contact with the bacterial biomass. In order to apply this method, it is recommended to contact a maximum volume of activated sludge with the uncoupling agent within a limited time period, in order to obtain optimum efficiency of the latter.

Thus, for biological pilot tests in the laboratory, the direct contact of the uncoupling agent with the bacterial biomass is designated by the expression of <<instantaneous dosage>> or <<instantaneous mixing>>, called flash mixing.

Moreover, the effective amount of uncoupling agents may represent from 0.1 to 1,000 milligrams per gram of solids present in the sludges (expressed as dry materials) in the aqueous system, preferably from 0.5 to 750 mg/g, for example, from 1 to 500 mg/g, such as from 5 to 100 mg/g.

By rapidly putting the bacterial biomass in direct contact (in other words with optimal mixing) with the uncoupling agent, it was found that this leads to improvement in the efficiency of the uncoupling agent by control of the bacterial biomass. It was discovered that if the uncoupling agent is simply directly added to a bioreactor containing sludges, then the efficiency of the agent is substantially reduced since the uncoupling agent is capable of interacting with the other materials present in the bioreactor and the action of this uncoupling agent is thereby substantially reduced.

The following examples illustrate the invention without limiting the scope thereof.

### EXAMPLE 1

### Demonstration of Sludge Reduction by an Organic Derivative in Oxitop Screening Tests

In order to evaluate the reduction in sludge production by a chemical uncoupling agent in screening, the respirometric technique of Oxitop® cylinders is used. Bacterial strains known and representative of activated sludge (since they are isolated in aeration tanks) are inoculated into a culture medium in the presence of a certain concentration of the uncoupling agent over a period of 7 days. By comparing the respiration of treated inocula comparatively with controls (untreated inocula), it is possible to measure oxygen overconsumption, a physiological signature of the uncoupling effect on bacteria.

The method and the apparatus used are those described in Example 3 of WO 2004/113236 cited as a reference.

The results obtained in a screening test on the bacterial strain Shinella granuli, are gathered in Table 1 below. They are expressed as an uncoupling percentage relative to the control (not comprising any uncoupling agent). THPS (tetrakis(hydromethyl)phosphonium sulfate) produces uncoupling effects in oxitop® respirometry tests of 16±8% for a rated concentration of 3 ppm, the 95% confidence interval of THPS in terms of uncoupling factor being [10-22], values calculated from results obtained in 26 Oxitop® tests.

TABLE 1

| | Concentrations | | | | | | | |
|---|---|---|---|---|---|---|---|---|
| | 0.1 ppm | 0.5 ppm | 1 ppm | 2 ppm | 3 ppm | 8 ppm | 10 ppm | 20 ppm |
| THPS | | | | | 16%* | | | |
| | | | | | [10-22] | | | |
| Vanillin | 5% | 18% | 14% | 18%-25% | 15%-22% | 21%-21% | 18%-23% | 18% |
| Penta- | | 2% | 8% | 15-17%- | 19% | 21-21%- | | 22% |
| erythritol | | | | 17% | | 19% | | |
| Glycine | 5% | 18% | 0% | 20%-26% | 24%-25% | 20%-26% | 12-20% | |
| betaine | | | | | | | | |

The toxicological and ecotoxicological properties of these molecules were evaluated at this stage in order to select the most promising molecules before passing to subsequent evaluation stages in biological pilots.

From Table 1, it emerges that:

Vanillin shows efficiency as early as 0.5 ppm and this up to 20 ppm.

Pentaerythritol shows efficiency in screening test in concentration ranges comprised between 2 and 20 ppm with a significant uncoupling factor since it is close to 20%.

Glycine betaine shows optimum efficiency in the 2 to 8 ppm concentration range.

1. A method for controlling the growth of bacterial biomass in an aqueous system, comprising adding to the aqueous system, or contacting with the aqueous system, an effective amount of an uncoupling agent selected from vanillin, pentaerythritol and a betaine of general formula (1):
(R)₃N⁺═[CH₂]ₙ═CO₂⁻ (1)
wherein:
the groups R, either identical or different, are selected from a linear or branched alkyl group, having from 1 to 8 carbon atoms and n is a number comprised between 1 and 5.

2. The method according to claim 1, characterized in that in formula (1), R is a methyl group and n=1, and the product of formula (1) is trimethylglycine, N-trimethyl-glycine, glycine betaine or glycine.

3. The method according to claim 1, characterized in that the effective amount of the uncoupling agent is comprised between 0.005 and 5,000 mg/l.

4. The method according to claim 3, characterized in that the effective amount of the uncoupling agent is comprised between 0.01 and 1,000 mg/l.

5. The method according to claim 4, characterized in that the effective amount of the uncoupling agent is comprised between 0.01 and 300 mg/l.

6. The method according to claim 5, characterized in that the effective amount of the uncoupling agent is comprised between 0.05 mg/l to 100 mg/l.

7. The method according to claim 6, characterized in that the effective amount of the uncoupling agent is comprised between 0.1 mg/l to 10 mg/l.

8. The method according to claim 7, characterized in that the effective amount of the uncoupling agent is comprised between 0.5 mg/l to 7.5 mg/l.

9. The method according to claim 8, characterized in that the effective amount of the uncoupling agent is comprised between 1 mg/l to 5 mg/l.

10. The method according to claim 1, characterized in that the effective amount of the uncoupling agent is comprised between 0.1 mg to 1,000 mg per gram of solids, expressed as dry material, present in the sludges in the aqueous system.

11. The method according to claim 10, characterized in that the effective amount of the uncoupling agent is comprised between 1 mg to 500 mg per gram of solids present in the sludges in the aqueous system.

12. The method according to claim 11, characterized in that the effective amount of the uncoupling agent is comprised between 5 mg to 100 mg per gram of solids present in the sludges in the aqueous system.

13. The method according to claim 1, characterized in that the aqueous system is a waste water treatment plant intended for treating industrial or municipal effluents.

14. The method according to claim 2, characterized in that the effective amount of the uncoupling agent is comprised between 0.005 and 5,000 mg/l.

15. The method according to claim 14, characterized in that the effective amount of the uncoupling agent is comprised between 0.01 and 1,000 mg/l.
